(19) United States
(12) Patent Application Publication
(10) Pub. No.: US 2004/0011223 A1
(43) Pub. Date: Jan. 22, 2004

(54) Food product with coated skewer and method for manufacturing same

(76) Inventor: William J. Odom JR., Sumter, SC (US)

Correspondence Address: Wright, Lindsey & Jennings LLP, Suite 2200, 200 West Capitol Avenue, Little Rock, AR, 72201-3699, US

(21) Appl. No.: 10/200,261

(22) Filed: Jul. 22, 2002

(51) Int. Cl. A23G 3/00

(52) U.S. Cl. 99/494

(57) ABSTRACT

A skewered food product in which not only the food portion but also the skewer itself is battered and breaded is disclosed. A method for manufacturing such a product for retail or foodservice sale is also disclosed.

### BACKGROUND OF THE INVENTION

The present invention relates to food products, and in particular to a breaded or battered food product that is presented on a breaded or battered skewer, and a method for manufacturing same.

Battered food products that are presented to consumers on a skewer are known in the art. U.S. Pat. No. 1,706,491 to Jenkins, for example, discloses an apparatus for preparing a battered food product on a skewer or stick. Jenkins discloses that the stick may be used as a convenient handle for the product. In this way, products may be served to consumers where the normal accoutrements of dining, such as a table, chair, dishes, utensils, and the like, are not available. A well-known example of such foods is the “corn dog,” a battered wiener served on a stick. The first corn dog was sold at the Texas State Fair in the 1930's, and they are still today commonly found at fairs, amusement parks, and other environments where it might be difficult for persons to consume traditional food products.

While such products are commonly served to adults and children alike, it has been found that food products presented on a stick or skewer are particularly enjoyed by children. The stick makes consumption easier for young children who have not yet fully developed the fine motor skills necessary to manipulate common eating utensils such as the knife, spoon, and fork. Older children simply enjoy the novelty of eating food presented on a stick, and associate such foods with amusement parks and other such places that they desire to visit.

The stick used for such products has generally been viewed as only a means by which to conveniently hold the food for consumption. In addition to Jenkins, U.S. Pat. No. 1,778,485 to Davidson and U.S. Pat. No. 3,717,473 to Bissett teach that the purpose of the stick is simply to provide a handle by which the food may be conveniently and sanitarily held for consumption. Sticks may also be used as a means of holding multiple food products together or as a means of holding the food product in a desired position; when used for these purposes, the skewers are usually pointed on at least one end for insertion into the food product. U.S. Pat. No. 4,027,044 to Taylor and U.S. Pat. No. 6,200,614 to Brawley provide examples of this use of skewers in various food products.

The skewers used with such products have generally not been considered to be a part of the food product itself, as the skewers or sticks are generally formed of wood or other nonconsumable materials. U.S. Pat. No. 2,116,310 to Harvey does, however, teach a food product on a stick where the stick is designed to hold certain flavoring products. Harvey teaches that the stick may be porous or slotted or otherwise designed to receive flavors, such as salt, pepper, mustard, relishes, and the like. The flavor of the stick thus enters the meat upon cooking. The purpose of the flavorings added to the stick is thus the enhancement of the flavor of the meat product, not the flavoring of the stick itself.

Despite decades of wide popularity for battered food products served on a skewer or stick, it has gone unrecognized that battering on the stick as well as the food product itself may be advantageous or desirable.

### BRIEF SUMMARY OF THE INVENTION

The present invention is directed to a battered or breaded food product presented on a skewer or stick in which the stick itself is breaded or battered along with the food portion of the product. It has been found that children, who are the most important consumer demographic for food products on a stick, find batter or breading on the stick as well as the food itself to be highly desirable. Children often enjoy eating the breading or batter portion of such products as much or more than the eating of the meat or other major food product component. Children are therefore encouraged to eat foods that are served to them by the use of the present invention.

The present invention is further directed to a method of manufacturing a food product that is battered or breaded and includes a stick that is also battered or breaded during the manufacturing process.

It is therefore an object of the present invention to provide for a breaded or battered food product on a skewer or stick for which the skewer or stick is itself breaded or battered.

It is a further object of the present invention to provide for a food product that is particularly enticing to children in order to encourage children to eat foods that are served to them.

These and other features, objects and advantages of the present invention will become better understood from a consideration of the following detailed description of the preferred embodiments and appended claims in conjunction with the drawings as described following:

### BRIEF DESCRIPTION OF THE SEVERAL VIEWS OF THE DRAWINGS

FIG. 1 is a partial cut-away perspective view of a preferred embodiment of the present invention.

FIG. 2 is a flow chart illustrating the first stage of a manufacturing process of a preferred embodiment of the present invention.

FIG. 3 is a flow chart illustrating the second stage of a manufacturing process of a preferred embodiment of the present invention.

### DETAILED DESCRIPTION OF THE INVENTION

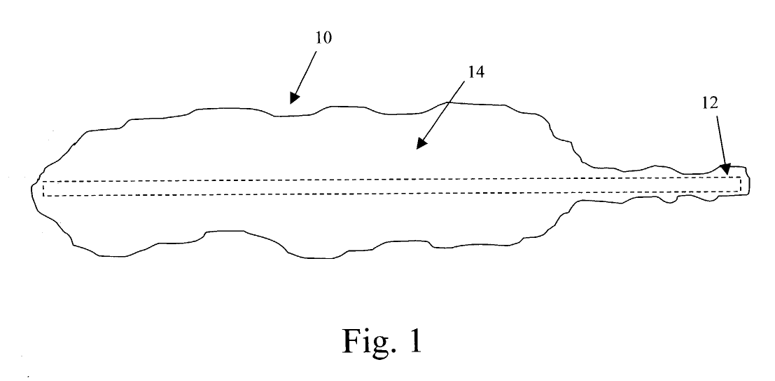

With reference to FIG. 1, a preferred embodiment of the present invention may be described. Food product 10 is presented on stick 12 and is encased in coating 14. Food product 10 is whole-muscle chicken in the preferred embodiment, as whole-muscle chicken is a nutritious, popular, yet relatively inexpensive food. Breast meat (when white meat is preferred) and thigh meat (when dark meat is preferred) are particularly desirable choices. In alternative embodiment, however, food product 10 may consist of processed chicken, or whole-muscle or processed forms of other meats, such as turkey, beef, pork, or the like. In addition, in other embodiments food product 10 may consist of foods other than meat, such as, for example, fruits or vegetables. Various forms of marinade may be used in conjunction with food product 10, which are applied to food product 10 as described more fully below.

Stick 12 is formed of wood in the preferred embodiment, since wood is light, inexpensive, safe for use in food products, and most importantly does not negatively impact food flavor when cooked with foods. Other materials may be used in alternative embodiments, however, such as metals or pressed papers. An edible form of stick 12 may also be used in certain embodiments; such sticks could be formed, for example, from highly compressed flour in combination with a binding agent.

In one preferred embodiment, one or both ends of stick 12 may be color coded as a means of distinguishing the marinade flavor employed with the product. This may be important during early processing, since products with multiple marinade flavors may be processed in succession and confusion might result without some means of distinguishing the products. Once batter and breading are applied to form coating 14, the color coding on stick 12 may no longer be visible, and therefore the utility of the color-coding feature may be limited to the early stages of processing as described below.

Coating 14 is preferably formed by covering food product 10 and stick 12 with batter and then breading. Any of the well known and popular forms of batter and breading combinations may be used. Other alternative embodiments may include a coating 14 that consists of only batter or of other edible coating materials.

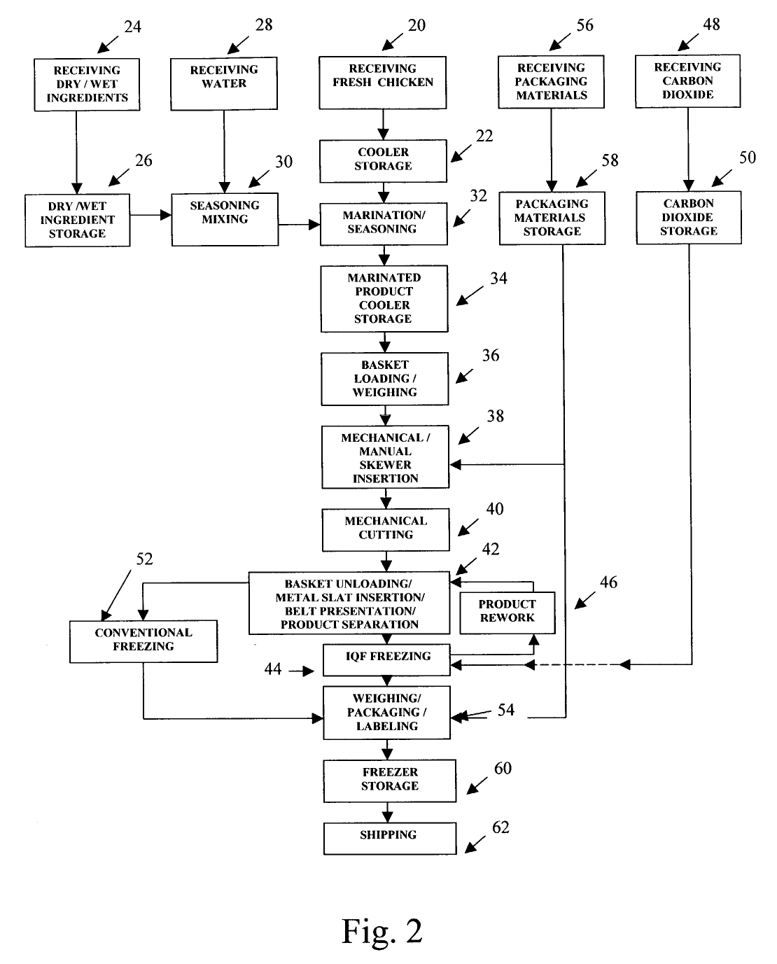

Referring now to FIG. 2, the first stage of a process for manufacturing a product according to a preferred embodiment of the present invention may now be described. At step 20, fresh, whole-muscle, boneless, skinless chicken (breast or thigh meat) is received at the processing facility. The chicken is transferred to a cooler for storage at step 22 in anticipation of further processing.

Ingredients to be used in the marinade for the product are received at step 24, and stored at step 26. Such materials are mixed according to the recipe to be used with potable water from step 28, with the resulting marinade created at step 30. The chicken is then vacuum tumble marinated at step 32. The marinated chicken is then transferred to storage in a cooler at step 34 to await further processing.

The marinated chicken is loaded into a basket at step 36 in order to facilitate weighing and further processing. The product is weighed at step 36 in order to ensure that a consistent quantity of product is simultaneously processed through with each basket. The sticks or skewers 12 are then inserted in the marinated chicken (food product 10) at step 38. It may be noted that while the preferred method of skewer insertion at step 38 is by automated machinery, skewers 12 may also be inserted manually by workers. If color-coded skewers 12 are to be used as described above with respect to a preferred embodiment, then the color marked on the skewer must match the particular marinade flavor chosen for this product. The preferred color marking medium is a food-grade dye, but other non-toxic marking materials may be used as well.

At step 40, the chicken is mechanically cut into strips such that individual food products are formed. Metal slats are then inserted into one side of the baskets at step 42 in order to separate the layers of chicken formed in the baskets. The baskets may then be opened and the slabs of skewered product placed on a conveyor belt, still at step 42. The skewered products may then be separated into individual products, and individually quick frozen (IQF) at step 44. It should be noted that to the extent the IQF process is incomplete with respect to certain individual products, the products may be resent through the separation and freezing process at step 46. Further, carbon dioxide used in the IQF process may be received at step 48 and stored in tank facilities at step 50. IQF is a process well known in the art for creating a frozen product that may be easily separated from like products packaged in the same container while still in the frozen state, thereby simplifying preparation or further processing. Alternatively, step 44 may be skipped in favor of conventional freezing of the product at step 52.

At step 54, the separated and frozen product is weighed and placed in shipping containers. Packaging materials for the shipping containers are received at step 56 and stored at step 58 to await use at step 54. The packaged product is stored in a freezer at step 60 until it is shipped to a coating facility at step 62. Alternatively, the facilities for initial processing and for coating may be located at the same physical plant, in which case one or more of steps 62, 60, 54, 58, 56, 44, 52, and 46 may be omitted.

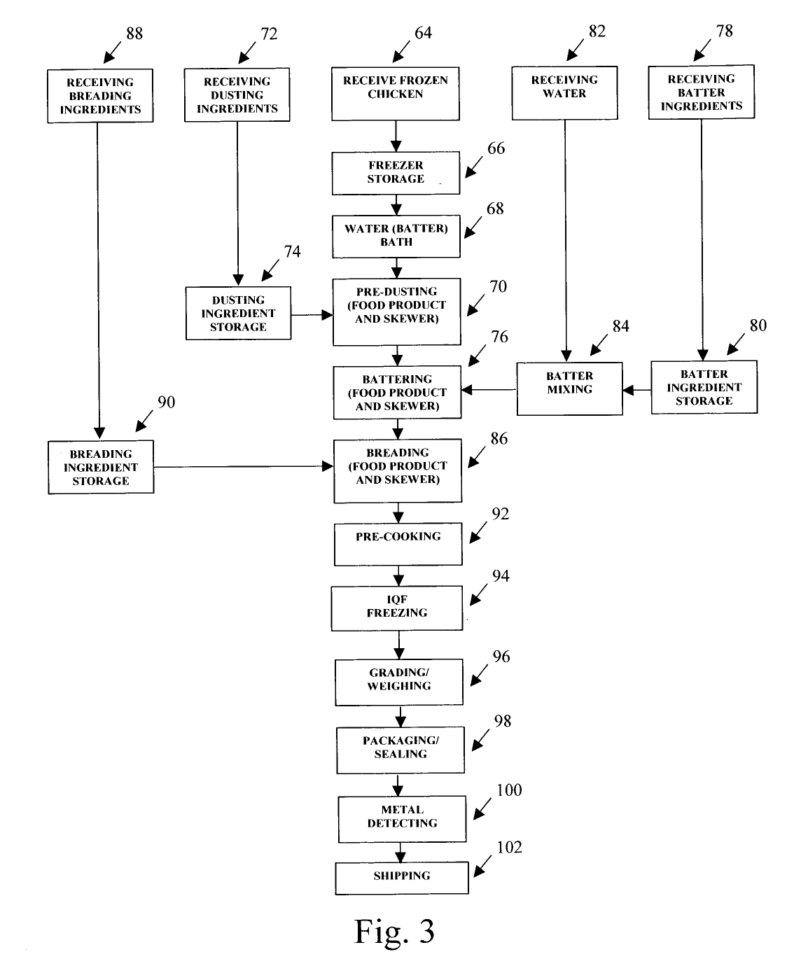

Referring now to FIG. 3, a second stage of product processing according to a preferred embodiment of the invention may be described. At step 64, frozen chicken is received and placed in a freezer at step 66 until further processing is commenced. The frozen product is placed on a conveyor belt and run through a water bath at step 68, which wets both the chicken and the portion of the skewer that extends from the chicken. Alternatively, a batter may be used in place of water at step 68, with the batter being described below. At step 70, the chicken and skewer are pre-dusted in preparation for receiving the batter coating. The dusting material ingredients are received at step 72 and stored at step 74. In a preferred embodiment, dusting material may comprise bleached enriched wheat flour (which contains niacin, iron, thiamine mononitrate, riboflavin, and folic acid), bread crumbs (which contain bleached wheat flour, dextrose, yeast, partially hydrogenated vegetable oil—soybean and/or cottonseed, and salt), salt, spices, garlic powder, whey, dextrose, extractives of paprika, and malted barley flour.

At step 76, a battering coat is applied to both the chicken and skewer 12, such that the entire product including the skewer 12 is coated with batter. Batter ingredients are received at step 78 and stored at step 80. In a preferred embodiment, the batter ingredients may comprise yellow corn flour, enriched bleached wheat flour, salt, leavening (which contains sodium acid pyrphosphate and sodium bicarbonate), guar gum, whey, and soy flour. Water received at step 82 is mixed with the batter ingredients to form batter at step 84; the batter is then made available to step 76 for battering of the product. Once batter is applied at step 76, breading is applied to the product at step 86. Breading ingredients are received at step 88 and stored until needed by step 86 at step 90. In a preferred embodiment, the breading ingredients may comprise bleached enriched wheat flour, bread crumbs, salt, spices, garlic powder, and extractives of paprika.

At step 92, the now battered and breaded product is pre-cooked for a short period of time in order to set the batter and breading. In a preferred embodiment, the pre-cooking time is set in order to complete pre-cooking with a cooking temperature of approximately 350 degrees. The product is then run through a spiral freezer, as are well known in the art, for IQF processing at step 94. When the product exits the freezer, it is graded for quality and weighed at step 96. The product is also bagged at this step, with cooking instructions either printed onto the bag directly or inserted into each bag for the use of the consumer or other food preparer. In the preferred embodiment, the product bags are heat sealed or taped, but other types of bag or container sealing may also be used.

The packaged product is passed through a metal detector at step 100 in order to ensure that no metal has entered the product during the course of processing. Code dating information and labels identifying the product may be applied to the packaging at this time. The product is then shipped to customers at step 102.

The present invention has been described with reference to certain preferred and alternative embodiments that are intended to be exemplary only and not limiting to the full scope of the present invention as set forth in the appended claims.

What is claimed is:

1. A food product, comprising:
(a) a food portion;
(b) a skewer disposed through said food item, said skewer further comprising a handle portion that extends from at least one end of said food portion with sufficient length that the food product may be grasped at said handle portion; and
(c) at least one of a batter and a breading, wherein said one of batter and breading covers said food item and covers at least a part of said handle portion.

2. The food product of claim 1, wherein said food portion comprises one of meat and poultry.

3. The food product of claim 1, wherein said one of batter and breading covers all of said handle portion.

4. The food product of claim 1, further comprising a marinade applied to said food portion, and wherein an end of said skewer is one of colored and void of color to indicate the flavor of said marinade.

5. A method for manufacturing a food product comprising a food portion, a skewer, and at least one of a batter and a breading, comprising the steps of:
(a) forming the food portion;
(b) inserting the skewer into said food portion, wherein a handle portion of the skewer extends from the food portion;
(c) coating the food product in one of a batter and breading, wherein the food portion and at least a part of the skewer are covered by the at least one of a batter and breading;
(d) precooking the food product; and
(e) freezing the food product.

6. The method of claim 5, wherein the food portion comprises a plurality of pieces of at least one of meat and poultry, and said forming step comprises the step of forming the pieces together as a single food portion.

7. The method of claim 5, further comprising the step of freezing said food product prior to said coating step.

8. The method of claim 5, wherein said precooking step is of a sufficient duration and temperature to set the at least one of a batter and breading.

9. The method of claim 5, wherein said freezing step comprises the step of individual quick freezing the food product.

10. The method of claim 5, further comprising the step of bathing the food product in one of a batter and water prior to said coating step.

11. The method of claim 10, further comprising the step of pre-dusting the food product subsequent to said bathing step and prior to said coating step.
